(19) United States
(12) Patent Application Publication
(10) Pub. No.: US 2019/0252802 A1
(43) Pub. Date: Aug. 15, 2019

(54) TERMINAL-ATTACHED ELECTRIC WIRE, METHOD FOR MANUFACTURING THE SAME, AND WIRE HARNESS

(71) Applicant: Yazaki Corporation, Tokyo (JP)

(72) Inventors: Tomoki OKUBO, Shizuoka (JP); Takayuki IMOTO, Shizuoka (JP)

(73) Assignee: Yazaki Corporation, Tokyo (JP)

(21) Appl. No.: 16/269,618

(22) Filed: Feb. 7, 2019

(30) Foreign Application Priority Data
Feb. 9, 2018 (JP) 2018-021893
Oct. 26, 2018 (JP) 2018-201888

(51) Int. Cl. H01R 4/20; H01B 7/00; H01R 43/048; H01B 13/012

(52) U.S. Cl. CPC H01R 4/20; H01B 13/012; H01R 43/048; H01B 7/0045

(57) ABSTRACT

A terminal-attached electric wire, a method for manufacturing the same, and a wire harness using the terminal-attached electric wire has an electric wire including a conductor and a sheath material covering the conductor, a crimp terminal connected to the conductor of the electric wire, and a coating film formed of a coating agent applied to an area including a connecting part between the conductor and the crimp terminal. The coating agent is formed of an alkyd resin.

### CROSS REFERENCE TO RELATED APPLICATION

This application is based upon and claims the benefit of priority from the prior Japanese Patent Application No. 2018-021893 (filing date: Feb. 9, 2018), and Japanese Patent Application No. 2018-201888 (filing date: Oct. 26, 2018), the entire contents of which are incorporated herein by reference.

### BACKGROUND

### Technical Field

The present invention relates to a terminal-attached electric wire, a method for manufacturing the same, and a wire harness.

### Related Art

Various electronic devices are mounted on a vehicle such as an automobile, and a wire harnesses using a terminal-attached electric wire is arranged in order to supply electric power to these electronic devices and to transmit various signals.

A general terminal-attached electric wire is obtained by eliminating (peeling) an insulating sheath formed of aluminum or the like at an end of an electric wire to expose a conductor and crimping and fixing this conductor with a front end of a terminal fitting formed of copper, a copper alloy, or the like.

The exposed conductor and the terminal fitting are brought into close contact with each other under a pressing state.

Here, in a case where the conductor and the terminal fitting are formed of different types of metals, if water or a chemical adheres to a connecting part, galvanic corrosion occurs in the conductor and the terminal fitting to deteriorate the terminal-attached electric wire and the wire harness.

Therefore, various techniques relating to a terminal-attached electric wire having a waterproof structure or a corrosion preventing structure at a connecting part have been proposed (see JP 2015-151617 A).

However, the technique disclosed in JP 2015-151617 A has the following disadvantages.

That is, a benzotriazole-based rust inhibitor or the like is an insulator, and therefore electrical connection with an electric wire is hindered disadvantageously in a case where the benzotriazole-based rust inhibitor is also applied to an exposed terminal cross section.

In addition, in a case where an ultraviolet curable resin, a photocurable resin, or the like is applied after a terminal fitting and an electric wire are bonded, a gap may be formed by shrinkage of a material due to crosslinking, and sealing performance is poor disadvantageously.

In addition, the benzotriazole-based rust inhibitor or the like has a three-layer structure, and has high management cost disadvantageously due to a large number of steps.

### SUMMARY

The present invention has been achieved in view of the above problems, and an object of the present invention is to provide a terminal-attached electric wire capable of improving waterproofness and corrosion preventing performance at relatively low cost, a method for manufacturing the same, and a wire harness.

A terminal-attached electric wire according to a first aspect of the present invention includes: an electric wire including a conductor and a sheath material covering the conductor; a crimp terminal connected to the conductor of the electric wire; and a coating film formed of a coating agent applied to an area including a connecting part between the conductor and the crimp terminal. The coating agent is formed of an alkyd resin.

A method for manufacturing a terminal-attached electric wire according to a second aspect of the present invention includes: connecting a crimp terminal to a conductor of an electric wire; applying a coating agent formed of an alkyd resin to an area including a connecting part between the conductor and the crimp terminal; and curing the coating agent to form a coating film.

A wire harness according to a third aspect of the present invention is a wire harness using the terminal-attached electric wire according to the first aspect.

The terminal-attached electric wire, the method for manufacturing the same, and the wire harness according to the aspects of the present invention can improve waterproofness and corrosion preventing performance at relatively low cost.

### BRIEF DESCRIPTION OF DRAWINGS

FIG. 1 is a perspective view illustrating an overall configuration of a terminal-attached electric wire according to an embodiment;

FIG. 2A is a process diagram illustrating a process for manufacturing a terminal fitting used for the terminal-attached electric wire according to the embodiment;

FIG. 2B is a process diagram illustrating a process for manufacturing a terminal fitting used for the terminal-attached electric wire according to the embodiment;

FIG. 3 is a perspective view illustrating a step following the process for manufacturing a terminal-attached electric wire illustrated in FIGS. 2A and 2B;

FIG. 4 is perspective view illustrating a step following the process for manufacturing a terminal-attached electric wire illustrated in FIG. 3;

FIG. 5 is a cross-sectional view illustrating a cross section of a main part of the terminal-attached electric wire according to the embodiment; and

FIG. 6 is a graph illustrating experimental results of a comparative example that has not been subjected to corrosion prevention and a test piece that has been subjected to corrosion prevention with a coating agent.

### DETAILED DESCRIPTION

### First Embodiment

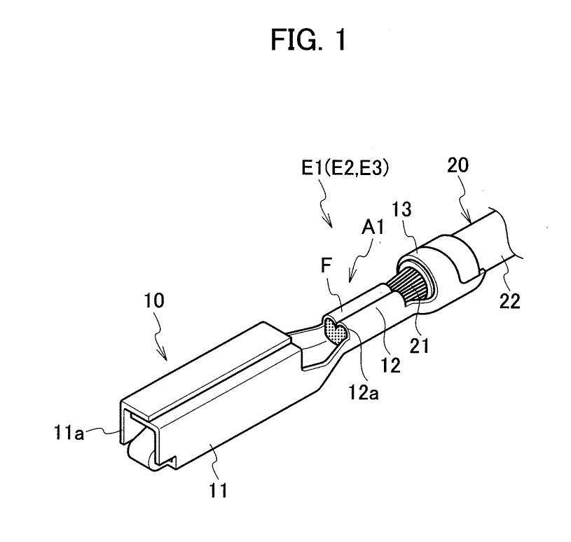

With reference to FIGS. 1 to 6, a terminal-attached electric wire E1 according to a first embodiment of the present invention will be described.

(Regarding Configuration Example of Terminal-Attached Electric Wire)

FIG. 1 is a perspective view illustrating an overall configuration of the terminal-attached electric wire E1 according to the present embodiment.

The terminal-attached electric wire E1 according to the present embodiment includes a conductor 21 formed of aluminum, an aluminum-based alloy, or the like, an electric wire 20 including a sheath material 22 covering the conductor 21, a crimp terminal (metal terminal) 10 connected to the conductor 21 of the electric wire 20, and a coating film F formed of a coating agent C1 applied to an area A1 including a connecting part between the conductor 21 and the crimp terminal 10.

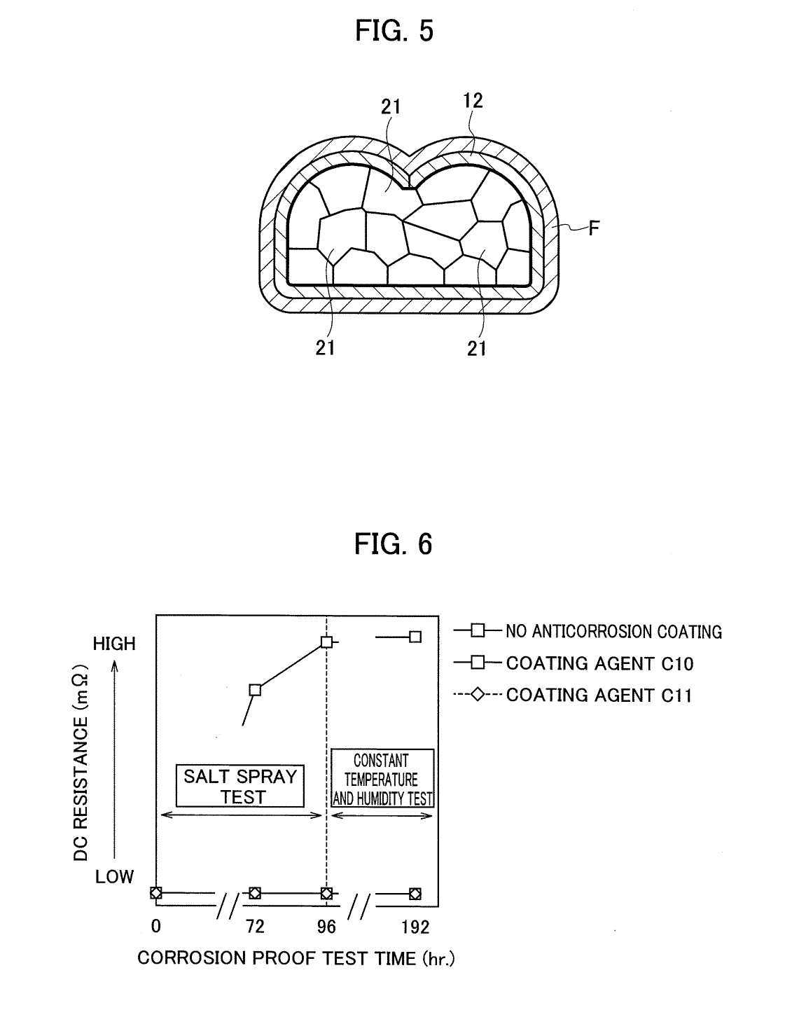

Note that the coating film F is formed around an end of the conductor 21 or the entire exposed portion of the conductor 21 (see FIG. 5 or the like).

Here, the coating agent C1 is formed of an alkyd resin. The alkyd resin is a synthetic resin formed of a polyester generated by a condensation reaction between a polyhydric alcohol and a polybasic acid.

The alkyd resin applied to the present embodiment contains any one of a short oil alkyd resin, a medium oil alkyd resin, a long oil alkyd resin, and a modified alkyd resin combined with a modifier.

The coating agent C1 may be manufactured by mixing two or more types of alkyd resins.

As the modifier, at least one of rosin, a phenolic resin, an epoxy resin, an acrylic resin, a vinyl monomer, and a silicone resin can be contained.

The coating agent C1 may be manufactured by mixing two or more types of modifiers.

The coating agent C1 may contain an antioxidant, a corrosion preventing agent, a rust inhibitor, a drying accelerator, and a filler as an additive.

Note that a conductive filler such as carbon black can be used as the filler. In a case where the coating agent C1 contains a conductive filler, the coating agent C1 may also be applied to a surface of the crimp terminal 10 on a side in contact with the conductor 21. The surface of the crimp terminal 10 on a side in contact with the conductor 21 may also include an end surface of the conductor constituting the crimp terminal 10.

Note that examples of the drying accelerator include cobalt octylate, manganese octylate, zinc octylate, and cobalt naphthenate. Use of the drying accelerator makes it possible to shorten drying time.

Furthermore, the coating agent C1 may contain a colorant as an additive. In this case, it is possible to easily confirm whether or not an application state of the coating agent C or a formation state of the coating film F on an applied surface is favorable by presence or absence of a color and a concentration, and to ensure more reliable waterproofness and corrosion preventing performance.

Note that carbon black or the like can be used as the colorant.

The coating agent C1 can be diluted with a predetermined solvent. In this case, fluidity of the coating agent C1 itself can be enhanced, and even a complicated shape or structure such as the conductor 21, the crimp terminal 10, or the connecting part between the conductor 21 and the crimp terminal 10 can be covered with the coating agent C1 along the shape or the like.

Note that toluene, xylene, or the like can be used as the solvent.

The conductor 21 and the crimp terminal 10 can be formed of the same type of metal (for example, aluminum, copper, a copper alloy, or the like for both thereof) or different types of metals (for example, a combination of aluminum, copper, a copper alloy, and the like).

The coating film F exhibits a waterproof effect. As a result, it is possible to exhibit a corrosion preventing effect or a rust inhibiting effect even when contact portion at the connecting part between the conductor 21 and the crimp terminal 10 are formed of the same type of metal or different types of metals.

(Regarding Crimp Terminal)

The crimp terminal 10 is, for example, formed as a terminal fitting having an alloy (base metal) plated (for example, Sn-plated).

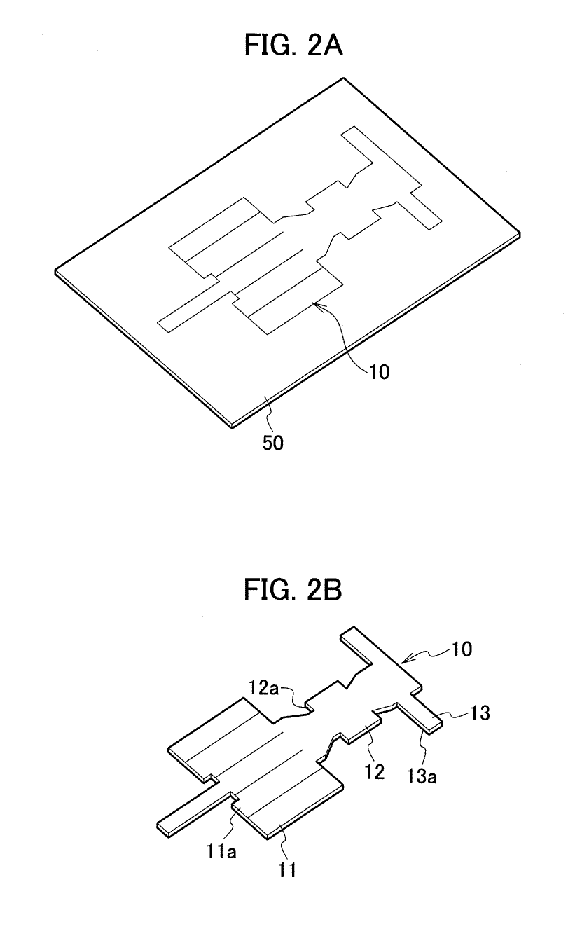

As illustrated in FIG. 2A, a metal plate 50 having an alloy (base metal) plated (for example, Sn-plated) is cut into a terminal shape.

The crimp terminal 10 illustrated in FIG. 2B includes a terminal portion 11 connected to a connector or the like, a bonded portion 12 for crimping and electrically bonding the conductor 21 of the electric wire 20, and a fixing portion 13 for crimping and fixing the sheath material 22 of the electric wire 20.

(Method for Manufacturing Terminal-Attached Electric Wire)

With reference to FIGS. 2A to 5, a method for manufacturing the terminal-attached electric wire E1 according to the present embodiment will be described.

First, the member (terminal fitting) 10 cut into a terminal shape as illustrated in FIG. 2B is cut out from the metal plate (base material) 50 formed of copper, a copper alloy, a SUS-based alloy, an aluminum-based alloy, or the like as illustrated in FIG. 2A by punching or the like.

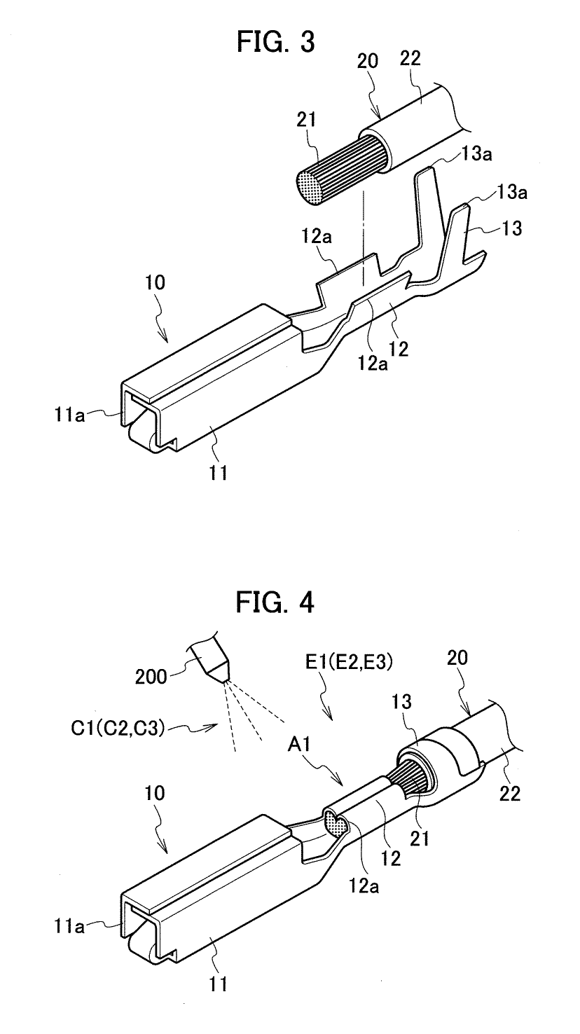

Next, as illustrated in FIG. 3, the member cut into a terminal shape is bent to form the crimp terminal 10. Then, the sheath material 22 on a distal end is eliminated, and the electric wire 20 with the conductor 21 exposed is attached to the crimp terminal 10.

Subsequently, as illustrated in FIG. 4, the conductor 21 of the electric wire 20 is crimped by the bonded portion 12 of the crimp terminal 10, and the sheath material 22 of the electric wire 20 is crimped by the fixing portion 13 of the crimp terminal 10 to crimp the crimp terminal 10 onto the electric wire 20.

Then, the coating agent C1 formed of an alkyd resin is applied to an area A1 including a connecting part between the conductor 21 and the crimp terminal 10, for example, with a sprayer (spray device) 200, in drops, or with a brush.

Subsequently, the applied coating agent C1 is dried. At this time, drying may be accelerated by irradiating the coating agent C with laser light or heat with a halogen heater or the like. This makes it possible to improve manufacturing efficiency of a terminal-attached electric wire.

The applied coating agent C1 formed of an alkyd resin reacts with oxygen in air to be cured. Therefore, it is possible to omit a step of emitting light or heat for curing unlike a case of using a photocurable resin or a thermosetting resin, and it is possible to further improve manufacturing efficiency of a terminal-attached electric wire.

In this way, the coating agent C1 formed of an alkyd resin is strongly bonded to metal surfaces of the conductor 21 and the crimp terminal 10 to form the coating film F, and the terminal-attached electric wire E1 as illustrated in FIG. 1 is formed.

Since the coating film F exhibits a waterproofing effect or a corrosion preventing effect with a relatively thin film thickness, the coating film F does not hinder a fitted state to a connector housing.

In a case where a coating agent C exhibits a predetermined color due to addition of a colorant, it is easy to confirm an application state in a working step by adjusting a concentration.

Furthermore, since the coating film F has a primer effect under a coating film, it is also possible to form another coating film on the coating film F or paint the coating film F.

Since the coating film F has heat resistance, the coating film F can be used even in a high-temperature environment as in an engine room of a vehicle.

By bundling a plurality of terminal-attached electric wires E to manufacture a wire harness, it is possible to provide a wire harness having waterproofness and corrosion preventing performance improved.

(Regarding experimental results) In order to confirm characteristics and effects of the coating film F as described above, the present inventor performed the following experiment.

First, the coating agent C formed of an alkyd resin was prepared.

Specifically, the coating agent C1 (C10 or C11) was prepared using “ARAKYD 7104” or “ARAKYD 7108” manufactured by Arakawa Chemical Industries, Ltd., which is one type of phenol-modified alkyd resin.

A tin-plated brass terminal was crimped onto an aluminum-based alloy, and a predetermined amount of the coating agent C10 or C11 prepared as described above was applied to a connecting part between a terminal fitting and an electric wire conductor and dried to obtain a test piece.

As a comparison object, a test piece not subjected to corrosion prevention was prepared.

Using the above test pieces, a salt-water spray test and a DC resistance measurement were performed according to the Japanese Industrial Standard (JIS) and the Japan Automobile Manufacturers Association (JASO) standard.

Specifically, the above two test pieces were subjected to a salt-water spray test according to JIS Z 2371 for 72 hours or 96 hours.

After the salt-water spray test, DC resistance of the connecting part between a terminal fitting and an electric wire conductor was measured for each of the test pieces.

Here, as a result of the DC resistance measurement, experimental results as illustrated in FIG. 6 were obtained regarding an increase in resistance after the salt-water spray test.

That is, the test piece that had not been subjected to corrosion prevention as a comparison object (NO ANTICORROSION COATING indicated in FIG. 6) largely increased DC resistance after the salt-water spray test was performed for 72 hours as compared with DC resistance before the salt-water spray test (0 h). Meanwhile, in the test piece that had been subjected to corrosion prevention using the coating agent C10 or C11, even in the test piece that had been subjected to a salt-water spray test for 72 hours or 96 hours, a large increase in DC resistance could not been confirmed.

As described above, it has been found that by applying the coating agent C10 or C11, it is possible to obtain a practically sufficient corrosion preventing effect for a terminal-attached electric wire.

Note that the coating agent C10 is ARAKYD (phenol-modified) 7104 manufactured by Arakawa Chemical Industries, Ltd., and the coating agent C11 is ARAKYD (phenol-modified) 7108 manufactured by Arakawa Chemical Industries, Ltd.

### (Regarding Confirmation of Corrosion Preventing Effect)

As a method for confirming a corrosion preventing effect, two tests described in JASO D 616 (1) a salt-water spray test for 96 hours at a temperature of 35° C. at a salt water concentration of 5% and 2) a constant temperature and constant humidity test for 96 hours at a temperature of 80° C. at a humidity of 95% according to JIS Z2371) were performed continuously, and then DC resistance was measured.

By crimping the aluminum electric wire onto the copper alloy terminal fitting, a contact portion formed of different types of metals electrically connected is formed.

A mixed solution containing a corrosion preventing agent: phenol-modified alkyd resin (ARAKYD 7104 manufactured by Arakawa Chemical Industries, Ltd. in this case) was applied to the contact portion and surroundings thereof as a post-treatment.

As illustrated in FIG. 6, the DC resistance of the test piece to which a corrosion preventing agent had not been applied exhibited a very large resistance value after the salt-water spray test was performed for 96 hours. Meanwhile, the test piece to which a corrosion preventing agent had been applied exhibited a similar resistance value to a value before the salt-water spray test even after the salt-water spray test was performed. This result indicates that it is possible to prevent or delay corrosion by applying a phenol-modified alkyd resin mixed solution. In addition, this result indicates that it is possible to maintain a corrosion preventing effect even under a high temperature and a high humidity because even after the constant temperature and constant humidity test was performed continuously for 96 hours after salt water was sprayed for 96 hours, a resistance value corresponding to a value before the test was exhibited.

As described above, it is possible to prevent or delay corrosion of a contact portion formed of different types of metals and a wire harness by applying a phenol-modified alkyd resin mixed solution.

### Second Embodiment

A terminal-attached electric wire E2 according to a second embodiment of the present invention will be described.

The overall configuration of the terminal-attached electric wire E2 according to the second embodiment is similar to the terminal-attached electric wire E1 according to the first embodiment.

A difference from the terminal-attached electric wire E1 according to the first embodiment is that an alkyd resin that can be used for both water and oil and has excellent corrosion preventing performance is used without using a volatile organic compound (VOC) as a corrosion preventing agent (coating agent).

More specifically, a water-dispersible alkyd resin is used, and water is used as a solvent.

Here, a general alkyd resin is used also for heavy corrosion prevention for a bridge or the like because of having favorable affinity with an oily surface, favorable adhesion thereto, and high corrosion preventing performance.

However, a general alkyd resin has a problem of environmental contamination due to volatile organic compound (VOC) used as a solvent. In addition, relatively long time is required for curing and drying disadvantageously. Therefore, in a case where a general alkyd resin is used for a product such as an automotive part, for example, it is necessary to perform VOC countermeasures and to add a drying step and a curing step, and management cost increases disadvantageously.

Meanwhile, in the present embodiment, a water-dispersible alkyd resin using water as a solvent is used as a corrosion preventing agent C2, and the corrosion preventing agent C2 is applied to a crimp terminal (metal terminal) 10 and an area A1 including a connecting part between a conductor 21 and the crimp terminal 10 (see FIG. 4).

Since the corrosion preventing agent C2 is temporarily cured by volatilization of water, it is possible to manufacture an electric wire and a wire harness preventing or delaying corrosion without a burden on a manufacturing process.

(Step of Curing Corrosion Preventing Agent C2 or the Like)

When the corrosion preventing agent C2 containing a water-dispersible alkyd resin and water is applied to the crimp terminal (metal terminal) 10 and the conductor 21, first, water is volatilized and fixed with a certain hardness. Thereafter, the fixed alkyd resin is gradually dried and cured by oxidative polymerization.

Then, when the corrosion preventing agent C2 completes drying and curing, the corrosion preventing agent C2 exhibits waterproof and corrosion preventing curing so as to prevent entry of water.

Incidentally, in the corrosion preventing agent C2, a water-dispersible alkyd resin is dispersed in water as a solvent. However, since the alkyd resin itself is lipophilic, even if processing oil or the like adheres to the corrosion preventing agent C2, the corrosion preventing agent C2 can be cured with firm adhesion. (Regarding confirmation of corrosion preventing effect)

First, as the corrosion preventing agent C2, a water-dispersible alkyd resin was prepared. Specifically, an aqueous alkyd resin paint “AQYLA” manufactured by Kusakabe Corporation was used.

Then a tin-plated brass terminal was crimped onto an aluminum-based alloy, and 10 to 20 μl of the corrosion preventing agent C2 was applied to a connecting part between a terminal fitting and an electric wire conductor and dried thoroughly. Note that drying was performed at a temperature of 23° C. for one month and a half.

As a comparison object, a test piece that had not been subjected to corrosion prevention was prepared.

Using the test pieces, a salt-water spray test was performed according to Japanese Industrial Standard (JIS), and then DC resistance was measured.

Specifically, the above two test pieces were subjected to a salt-water spray test according to JIS Z 2371 for 96 hours.

Subsequently, after the salt-water spray test, DC resistance of the connecting part between a terminal fitting and an electric wire conductor was measured for each of the test pieces.

Here, as a result of the DC resistance measurement, regarding an increase in resistance after the salt-water spray test, the test piece that had not been subjected to corrosion prevention as a comparison object largely increased DC resistance after the salt-water spray test was performed for 72 hours as compared with DC resistance before the salt-water spray test (0 h). Meanwhile, in the test piece that had been subjected to corrosion prevention using the corrosion preventing agent C2, even in the test piece that had been subjected to a salt-water spray test for 96 hours, a large increase in DC resistance could not been confirmed. Note that whether or not a resistance value was favorable was judged based on whether or not resistance of a crimp portion exceeded 10 mΩ.

As described above, the corrosion preventing agent C2 using a water-dispersible alkyd resin according to the present embodiment can reduce the total amount of VOC used as a solvent used in another coating agent to reduce a burden on environment or a process.

### Third Embodiment

A terminal-attached electric wire E3 according to a third embodiment of the present invention will be described.

The overall configuration of the terminal-attached electric wire E3 according to the third embodiment is similar to the terminal-attached electric wire E1 according to the first embodiment.

A difference from the terminal-attached electric wire E1 according to the first embodiment or the like is that a corrosion preventing agent (coating agent) C3 used for the terminal-attached electric wire E3 according to the third embodiment includes a main curing agent for guaranteeing corrosion preventing performance of a coating film F and a temporary curing agent for maintaining the quality of the corrosion preventing agent C3 applied in a manufacturing process, the main curing agent is formed of an alkyd resin, and the temporary curing agent is formed of a solvent or a rapidly curable resin.

More specifically, the alkyd resin of the corrosion preventing agent C3 may contain a phenol-modified alkyd resin, and the rapidly curable resin may contain an ultraviolet curable resin.

Here, the alkyd resin is inexpensive and has excellent corrosion preventing performance, and is also used for heavy corrosion prevention for a bridge or the like. However, time required for curing and drying is relatively long. Even when a drying accelerator or the like is added, a few hours are required until curing and drying are completed in many cases.

In addition, if drying is completed too fast, a defect such as wrinkles is generated on a surface of a product disadvantageously.

Therefore, in a case where an alkyd resin is applied to a wire harness, an increase in time to shift to a subsequent step, an increase in a failure occurrence rate of a product, and the like are assumed due to curing and drying time, and there may be a burden e on the steps.

Meanwhile, according to the present embodiment, by applying a composite of an alkyd resin (main curing agent) for guaranteeing corrosion preventing performance and a rapidly curable resin or a solvent for maintaining a favorable product in a manufacturing process (temporary curing agent) to the crimp terminal (metal terminal) 10 and the conductor 21 as the corrosion preventing agent C3, it is possible to manufacture an electric wire and a wire harness capable of preventing or delaying corrosion inexpensively without a burden on a manufacturing process.

Examples of the corrosion preventing agent C3 include a corrosion preventing agent obtained by mixing a phenol-modified alkyd resin and an ultraviolet (UV) curable resin.

(Step of Curing Corrosion Preventing Agent C3 or the Like)

The corrosion preventing agent C3 obtained by mixing an alkyd resin and a UV curable resin is applied to the crimp terminal (metal terminal) 10 and the conductor 21, and the coated portion is irradiated with ultraviolet rays (UV) required for curing the UV curing resin.

As a result, complete curing is not reached, but temporary curing occurs to a degree of touch drying or surface drying considered to be minimum curing required in a process.

In a temporarily cured state, sufficient corrosion preventing performance cannot be obtained. However, in the alkyd resin portion, main curing progresses gradually by oxidative polymerization, and a sufficient corrosion preventing effect can be obtained when main curing is completed.

Note that the main curing step only needs to be completed before shipment or delivery of a product.

By changing a mixing ratio between the alkyd resin and the UV curable resin, it is possible to control hardness at the time of temporary curing, curing, a drying speed, corrosion preventing performance after main curing, and the like.

In place of the alkyd resin, for example, an acrylic resin, an epoxy-based resin, a phenol-based resin, a urethane-based resin, a silicone-based resin, or a fluorine-based resin may be used.

As a curing and drying mechanism of the rapidly curable resin, any one of volatilization, fusion bonding, oxidative polymerization, polymerization, thermal polymerization, melting cooling, ultraviolet/electron beam curing, and the like may be used.

Hereinabove, the terminal-attached electric wire according to an aspect of the present invention has been described based on the illustrated embodiments. However, the present invention is not limited thereto, and the configuration of each part may be replaced with any configuration having a similar function.

What is claimed is:

1. A terminal-attached electric wire comprising:
an electric wire including a conductor and a sheath material covering the conductor;
a crimp terminal connected to the conductor of the electric wire; and
a coating film formed of a coating agent applied to an area including a connecting part between the conductor and the crimp terminal, wherein
the coating agent is formed of an alkyd resin.

2. The terminal-attached electric wire according to claim 1, wherein the conductor and the crimp terminal are formed of the same type of metal or different types of metals.

3. The terminal-attached electric wire according to claim 1, wherein the alkyd resin contains any one of a short oil alkyd resin, a medium oil alkyd resin, a long oil alkyd resin, and a modified alkyd resin combined with a modifier.

4. The terminal-attached electric wire according to claim 3, wherein the modifier contains at least one of rosin, a phenolic resin, an epoxy resin, an acrylic resin, a vinyl monomer, and a silicone resin.

5. The terminal-attached electric wire according to claim 1, wherein the coating agent contains at least one of an antioxidant, a corrosion preventing agent, a rust inhibitor, a drying accelerator, and a filler as an additive.

6. The terminal-attached electric wire according to claim 1 wherein the coating agent contains a colorant as an additive.

7. The terminal-attached electric wire according to claim 1, wherein the coating agent is diluted with a solvent.

8. The terminal-attached electric wire according to claim 7, wherein
the alkyd resin is formed of a water-dispersible alkyd resin, and
the solvent is water.

9. The terminal-attached electric wire according to claim 1, wherein
the coating agent contains a main curing agent for guaranteeing corrosion preventing performance of a coating film and a temporary curing agent for maintaining a quality of the coating agent applied in a manufacturing process,
the main curing agent is formed of the alkyd resin, and
the temporary curing agent is formed of a rapidly curable resin or a solvent.

10. The terminal-attached electric wire according to claim 9, wherein
the alkyd resin contains a phenol-modified alkyd resin, and
the rapidly curable resin contains an ultraviolet curable resin.

11. The terminal-attached electric wire according to claim 1, wherein a surface of the crimp terminal on a contact side to which the coating agent is applied includes an end surface of the conductor.

12. A method for manufacturing a terminal-attached electric wire, comprising:
connecting a crimp terminal to a conductor of an electric wire;
applying a coating agent formed of an alkyd resin to an area including a connecting part between the conductor and the crimp terminal; and
curing the coating agent to form a coating film.

13. The method for manufacturing a terminal-attached electric wire according to claim 12, wherein the coating agent applied to an area including a connecting part between the conductor and the crimp terminal is irradiated with laser light to be dried.

14. A wire harness using the terminal-attached electric wire according to claim 1.
